(19) United States
(12) Patent Application Publication
(10) Pub. No.: US 2007/0196539 A1
(43) Pub. Date: Aug. 23, 2007

(54) Composition and method for preparing food and beverage products with improved taste impression containing protein and fruit juices nutritionally supplemented with calcium and trace minerals

(75) Inventors: David K. Yang, Manhattan, KS (US); Janti S. Karr, St. George, KS (US)

Correspondence Address: JAGTIANI + GUTTAG, 10363-A DEMOCRACY LANE, FAIRFAX, VA, 22030, US

(73) Assignee: Nutrijoy, Inc., Manhattan, KS (US)

(21) Appl. No.: 11/708,049

(22) Filed: Feb. 20, 2007

Related U.S. Application Data
(60) Provisional application No. 60/775,368, filed on Feb. 21, 2006.

(51) Int. Cl. A23L 1/30

(52) U.S. Cl. 426/74

(57) ABSTRACT

The present invention provides a food product comprising: calcium citrate malate in an amount providing a level of solubilized calcium of at least about 0.18% by weight of the product, and a level of total acids of at least about 0.7% by weight of the product; vitamin D in an amount of at least about 10% of the RDA; one or more trace minerals in an amount of at least about 10% of the RDA of each trace mineral provided; and a stabilized buffering protein component in an amount of at least about 0.1% by weight of the product. A method for forming such a calcium and trace mineral fortified product is also provided which uses a stabilized acidified buffering protein component.

### CROSS-REFERENCE TO RELATED APPLICATIONS

This application makes reference to and claims the priority date of the following co-pending U.S. Provisional Patent Application: U.S. Provisional Patent Application No. 60/775,368, entitled “Composition and Method for Preparing Food and Beverage Products with Improved Taste Impression Containing Protein and Fruit Juices Nutritionally Supplemented with Calcium and Trace Minerals,” filed Feb. 21, 2006. The entire disclosure and contents of the above application is hereby incorporated by reference.

### BACKGROUND

1. Field of the Invention

The present invention relates generally to a food product fortified with highly solubilized calcium, vitamin D and trace minerals having an improved taste impression comprising calcium citrate malate, vitamin D and a stabilized buffering protein component. The present invention further generally relates to a method for preparing such a food product by using a stabilized acidified buffering protein component.

2. Related Art

Calcium fortification of beverages may be difficult because of the poor solubility of calcium salts in solution. This poor solubility may not only cause precipitation in these fortified products but also may also cause a chalky taste and undesirable aftertaste problems. For example, highly soluble calcium sources, for example, calcium citrate malate (CCM) is known to be highly soluble for juice beverage applications and may be more bioavailable than other calcium fortification source to benefit bone health. See, for example, U.S. Pat. No. 4,722,847 (Heckert), issued Feb. 2, 1988, and U.S. Pat. No. 4,737,375 (Nakel et al.), issued Apr. 12, 1988.

But at significant calcium fortification levels (e.g., greater than about 0.12% by weight calcium), total acidity may need to be increased in order to maintain calcium solubility and prevent the precipitation of insoluble calcium salts. This higher acidity, while improving solubility and stability, may also be detrimental to the palatability and taste quality of the product by imparting, for example, unacceptable sourness and unpleasant aftertastes. Accordingly, there is still a need for higher acidity food (e.g., beverage) products allowing for significant fortification with highly solubilized calcium, as well as vitamin D and other trace minerals, having improved taste impressions, as well as improved overall taste acceptance.

### SUMMARY

According to a first broad aspect of the present invention, there is provided a food product comprising:
calcium citrate malate in an amount providing a level of solubilized calcium of at least about 0.18% by weight of the product, and a level of total acids of at least about 0.7% by weight of the product;
vitamin D in an amount of at least about 10% of the RDA;
one or more trace minerals in an amount of at least about 10% of the RDA of each trace mineral provided; and
a stabilized buffering protein component.

According to a second broad aspect of the invention, there is provided a method comprising the following steps:
(a) providing a stabilized acidified buffering protein component; and
(b) combining the stabilized acidified buffering protein component with the remaining food product ingredients comprising calcium citrate malate, vitamin D and one or more trace minerals to form a calcium, vitamin D and trace mineral fortified food product. wherein the calcium citrate malate is in amount to provide a level of solubilized calcium of at least about 0.18% by weight of the food product, and a level of total acids of at least about 0.7% by weight of the food product, wherein the vitamin D is in an amount of at least about 10% of the RDA, and wherein the one or more trace minerals are in an amount to provide at least about 10% of the RDA of each trace mineral provided.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “food additive” refers to the common meaning of the term “food additive” and includes any product classified as a “food additive” by the U.S. Food and Drug Administration. Food additives may include non-caloric sweeteners, colorants, bulking agents (e.g., polydextrose), fat substitutes such as olestra, etc.

For the purposes of the present invention, the terms “food”, “food ingredient” or “food product” refer to the common meaning of these terms and include any product classified as a “food” by the U.S. Food and Drug Administration, including weight loss products, meal replacement products, supplement products (e.g., liquid supplement products), etc. Food products may include any product that may be directly drunk or ingested or that may be further mixed with other ingredients, further processed, etc., to form a product that may be drunk or ingested. For example, a food product may be mixed with a liquid to form a drink, added to flour and baked to form a bakery product, etc. A food product of the present invention may in various forms such as, for example, a liquid, a frozen or semi-frozen liquid, a nutritional supplement, a nutritional bar, a nutritional beverage, a candy bar, a powder (e.g., a beverage powder, etc.), a baked good (e.g., a cookie, a cake, etc.), pudding, sauce, gravy, soup, broth, soup consomme, cake frosting, ice cream, yogurt, custard, gelatin dessert, apple sauce, cottage cheese, cereal, bread, cheese, cheese spreads, chocolate (e.g., milk chocolate), liquid drinks such as fruit juices such as: apple juice, orange juice, grape juice, grapefruit juice, cranberry juice, etc., vegetable juices such as tomato juice, carrot juice, etc., mixtures of fruit and/or vegetable juices, coffee, tea, milk, milkshakes, hot chocolate, espressos, cappuccinos, lattés, etc.

For the purposes of the present invention the term “serving” refers to the appropriate serving size for a food product, for example, a nutritional beverage, nutritional composition, weight loss product, meal substitute, etc., as established by the United States Food and Drug Administration (FDA) and the Nutrition and Labeling Act (NLEA), as set forth in 21 C.F.R §101, or any subsequent version of the FDA regulatory rules that may correspond to 21 C.F.R §101. The present invention also adopts the NLEA's definition of a serving size as being the amount of food customarily eaten at one time. When the food product of the present invention comprises a nutritional beverage or liquid meal substitute, a typical serving size may be from about 230 to about 530 mL. A single serving of the food product may be packaged in various types of, for example, “single serving” packages/containers that are well known in the art.

For the purposes of the present invention, the terms “solids basis” and “dry basis” refer interchangeably to the weight percentage of each of the respective solid materials (e.g., calcium citrate malate, vitamin D, trace mineral(s), protein, etc.) present in the absence of any liquids (e.g., water).

For the purposes of the present invention, the terms “container” and “package” are used interchangeably and refer to a package or container that contains the food product of the present invention. The specific type of package or container, either of a single-serving size or any other size, used as a container for the food product may depend on such factors as whether the food product is a liquid, solid, powder, etc. whether the food product includes perishable components, components that need to be refrigerated, etc.

For the purposes of the present invention, the term “liquid food” or “liquid food product” refers to any food that is liquid at room temperature. Liquid foods may be in the form of solutions, colloidal suspensions, thixotropic mixtures, etc., for example, aqueous foods (i.e., those comprising water as a suspending agent, solubilizing agent, carrier, etc., with or without other suspending agents, solubilizing agents, carriers, etc., such, as for example, alcohol, etc.). Examples of liquid foods may include: bottled water, carbonated beverages (e.g., soda), fruit juices, vegetable juices, coffee, tea, milk, shakes, ice cream, puddings, pie fillings, etc.

For the purposes of the present invention, the term “edible” refers to any material, ingredient, additive, etc., which may be ingested and which is safe for humans to eat.

For the purposes of the present invention, the terms “ready-to-eat” (R-T-E) or “ready-to-drink” (R-T-D) refer, respectively, to a food product or a beverage product that is essentially ready for human consumption with minimal or no additional preparation such as cooking, heating, etc.

For the purposes of the present invention, the term “edible acid” refers to any acid that is edible. Suitable edible acids may include citric acid, malic acid, fumaric acid, maleic acid, tartaric acid, succinic acid, malonic acid, glutaric acid, adipic acid, aspartic acid, glutaconic acid, glutamic acid, phosphoric, etc.

For the purposes of the present invention, the term “acidulant” refers to one or more edible acids used in foods and/or beverages to impart a tart, sour, etc., taste to the food or beverage product, to maintain a lower pH in the product, to function as preservative in the product, etc.

For the purposes of the present invention, the term “solubilized calcium” refers to any source of calcium which may be solubilized in water or other aqueous environment (e.g., fruit juice) and which may provide bioavailable calcium in the gut. The sources of solubilized calcium source may be any water-soluble organic or inorganic salt, or a mixture of organic or inorganic salts. Sources of solubilized calcium may include calcium hydroxide, calcium chloride, calcium citrate, calcium malate, calcium citrate malate, calcium carbonate, calcium phosphate (e.g., monobasic calcium phosphate, dibasic calcium phosphate, tricalcium phosphate, etc.), calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, calcium tartrate, etc., or mixtures thereof.

For the purposes of the present invention, the term “calcium citrate malate” refers to an at least meta-stable complex of calcium with citrate and malate anions. Besides increasing calcium solubilization, another benefit of calcium citrate malate is that this complex does not interfere, or at least does not interfere in a significant way with the bioavailability or absorption of other minerals, including trace minerals.

For the purposes of the present invention, the term “bioavailable” refers to a calcium source which is available for absorption by the gut.

For the purposes of the present invention, the term “high shear mixing conditions” refers to mixing conditions, for example, under a combination of impeller velocity and tank turnover (determined by batch size and solution viscosity), which may form stabilized particles having a median particle size of less than about 0.8 microns (e.g., from about 0.2 to about 0.6 microns) without requiring a homogenization process step. High shear mixing conditions may be created using numerous commercial mixing systems, for example, Likwifier, Liquiverter, etc. These mixing conditions may be exemplified by, but are not limited to, a pitch blade turbine operated with an impeller velocity of at least about 1000 ft/min. (900 rpm, 2.54 inch impeller) for a 650 ml batch in a 1.25 liter vessel. Other high shear mixers, mixer blade configurations, high shear roto-stator devices, etc., with a shear rate of least about 45,000 sec⁻¹ may also be employed.

For the purposes of the present invention, the term “vitamin D” refers to compounds, compositions, etc., which may include vitamin D₃, vitamin D₂, 25(OH)D₃, 25(OH)D₂, 1α,25(OH)₂D₃, 1α,25(OH)₂D₂, etc., as well as mixtures thereof.

For the purposes of the present invention, the term “trace minerals” refers to those minerals which are important for bone growth and age-related bone health. These trace minerals may include iron, zinc, magnesium, manganese, copper, optionally potassium, etc., as well as mixtures thereof.

For the purposes of the present invention, the term “RDA” refers to the Recommended Dietary Allowances for various vitamins and minerals, including calcium, vitamin D and other trace minerals. These Recommended Dietary Allowances (RDAs) are a set of estimated nutrient allowances established by the National Academy of Sciences, which are updated periodically to reflect current scientific knowledge.

For the purposes of the present invention, the term “protein” refers to milk protein (e.g., dairy proteins, other mammalian milk proteins, etc.), vegetable proteins (e.g., soy protein, cereal proteins, rice milk proteins, other vegetable proteins, etc.), or any combination of such proteins.

For the purposes of the present invention, the term “soy protein” refers to any protein that may be derived from soy beans, whether or not the protein is actually derived from soy beans. The term “soy protein” also refers collectively to a mixture of two more soy proteins derived from soy beans. For example, a “soy protein” may be a mixture of soy proteins.

For the purposes of the present invention, the term “dairy protein” refers to whole milk casein, whey protein, protein fractions, hydrolyzed casein, whey protein fractions, etc., as well as mixtures thereof.

For the purposes of the present invention, the term “high acid environment” refers to a pH of about 4.2 or less. For example, such a high acid environment may comprise total acids of at least about 0.7% by weight of the product, e.g., in the range of from about 0.7% to about 2.6% by weight of the product.

For the purposes of the present invention, the term “buffering protein component” refers to the protein component that provides buffering in the food product in the presence of a high acid environment.

For the purposes of the present invention, the term “stabilized buffering protein component” refers to a buffering protein component which has been stabilized against calcium interactions and denaturing by an acid environment due to the inclusion of, for example, a gum stabilizer.

For the purposes of the present invention, the term “stabilized acidified protein premix” refers to a buffering protein component which has been acidified and stabilized prior to addition to, incorporation into, etc., the food product.

For the purposes of the present invention, the term “gum stabilizer” refers to gums which create a protective barrier around protein(s), thus preventing the protein(s) from coagulating when exposed to acids below the protein's isoelectric point. This gum stabilizer barrier may also prevent cation cross linking which may form gels. Suitable food grade gum stabilizers include pectin (e.g., a high methoxy pectin having a degree of methoxylation of greater than about 50% wherein the carboxyl units are methyl esters), gum acacia, cellulose gums, for example, carboxymethylcellulose (CMC), methylcellulose, and hydroxyethylcellulose, hydroxypropylcellulose, microcrystalline cellulose, etc., modified food starches, guar gum, xanthan gum, locust bean gum, gellan gum, gum arabic furcellaran, alginates, carrageenans, such as iota, kappa, lambda carrageenan, various agaroid gums and gum components, etc., or combinations thereof, e.g., a combination of pectin and CMC (carboxymethylcellulose) which has been found to work synergistically as a gum stabilizer or at least provide greater stability benefits than either ingredient separately.

For the purposes of the present invention, the term “fruit juice product” refers to both fruit juice beverages and fruit juice concentrates which comprise at least about 5% fruit juice on a single-strength basis.

For the purposes of the present invention, the term “fruit juice-based beverage” refers to a fruit juice product which is in a single-strength, ready-to-serve, drinkable form. For the purposes of the present invention, the terms “single-strength” and “ready-to-serve” are used interchangeably. Fruit juice beverages may be of the “partial strength” type which may comprise up to about 40% fruit juice by weight of the beverage, for example, from about 5 to about 20% fruit juice (e.g., from about 5 to about 10 fruit juice), or may be of the “full-strength” type which may comprise greater than about 40% fruit juice, for example, at least about 95% fruit juice. Fruit juice beverages may also include extended juice products which are referred to as “nectars” which may comprise from about 50 to about 90% fruit juice, for example, from about 50 to about 70% fruit juice.

For the purposes of the present invention, the term “fruit juice concentrate” refers to a fruit juice product which, when diluted with the appropriate amount of water, forms drinkable fruit juice-based beverages. Fruit juice concentrates may be formulated, for example, to provide drinkable beverages when diluted with 3 to 5 parts by weight water.

For the purposes of the present invention, the term “concentrated fruit juice” refers to fruit juice from which a portion of the water has been removed.

For the purposes of the present invention, the term “fruit juice materials” refers to fruit juice, plus other fruit juice materials such as, for example, fruit juice aroma and flavor volatiles, peel oils, pulp or pomace, etc.

For the purposes of the present invention, the term “fruit juice” refers to citrus juices, noncitrus juices such as apple juice, grape juice, pear juice, cherry juice, berry juice, pineapple juice, peach juice, apricot juice, plum juice, prune juice, etc., and mixtures of these juices.

For the purposes of the present invention, the term “citrus juice” refers to fruit juices selected from orange juice, lemon juice, lime juice, grapefruit juice, tangerine juice etc., and mixtures of these juices.

### Description

The present invention relates to nutritionally supplemented food and beverage products, including but not limited to, spoon-able puddings, gelatins, cultured fruit and dairy products, meal replacement beverages, liquid supplements, frozen treats, etc., which may have a pH in the range of from about 2.5 to about 4.2 and which are fortified with significant levels of solubilized calcium of at least about 0.18% by weight of the product (e.g., in the range of from about 0.18% to about 0.42% by weight of the product), at least about 10% of the RDA (e.g., from about 10 to 100% of the RDA) of vitamin D, and at least about 10% of the RDA (e.g., from about 10 to about 50% of the RDA) of one or more other trace minerals which may include iron, zinc, potassium, magnesium, manganese, and copper; important nutrients for bone growth and age-related bone health, and which contain a stabilized buffering protein component. In addition to the significant levels of calcium, vitamin D and trace minerals, other optional ingredients which may be present in, for example, fruit juice-based products, for example, fruit juice(s), other beneficial vitamins (e.g., A, E, C, etc.), as well as other nutrient fortification, for example dietary fiber, etc. For example, various dietary fiber sources may be included in the products of the present invention. These dietary fiber sources may be both soluble and insoluble types, and may be derived from such materials as oat fiber, soy fiber, guar gum, pectin, soy polysaccharides, gum arabic, hydrolyzed fibers, cellulose, hemicellulose, hydrocolloids, methylcellulose, carboxymethyl cellulose, fructooligosaccharides, etc.

An embodiment of a highly solubilized meta-stable complex of calcium citrate malate may be prepared by the addition of, for example, calcium carbonate, calcium oxide, calcium hydroxide, etc., to an aqueous solution of acids which includes citric and malic acid in a molar ratio of citric acid and malic acids to calcium in, for example, the molar range of from about 2:3:6 to about 2:3.5:5 (e.g., about 2:3:5), respectively. The level of solubilized calcium is at least about 0.18% by weight of the final product and may be in the range of from about 0.18 to about 0.42% by weight (e.g., from about 0.19 to about 0.38% by weight). The level of total acids depends on the product composition involved, for example, the level of fruit juices, the desired level of solubilized calcium, etc., but the level of total acids may be in an amount of at least about 0.7% by weight and in the range from about 0.7 to about 2.6% by weight (e.g., from about 0.7 to about 2% by weight). While other edible acids such as phosphoric acid, fumaric acid, etc., may also be included with the fruit juice(s), the acid component may comprise or consist essentially of a mixture of citric and malic acids. The weight ratio of citric acid to malic acid may be in the range of from about 2:1 to about 1:3 (e.g., from about 5:4 to about 1:3). After the solubilized complex calcium citrate malate is prepared, this mixture may be added to, for example, fruit juice and other formulation ingredients; for example, sweeteners, flavors, etc., to further stabilize the calcium citrate malate complex, to maintain appropriate acidity, etc.

Providing such significant levels of solubilized calcium, as well as vitamin D and other trace minerals, at relatively high fortification levels in such high acid environments without detrimental affects to taste, e.g., chalkiness, “biting/burning” sourness, etc., is not easy to achieve. For example, calcium and these trace minerals may impart a noticeable and negative taste impact to a food product, e.g., a beverage. While one of the benefits of these high acid levels is to help to overcome some of these taste negatives, in addition to solubilizing the calcium and trace minerals, a balancing of the taste effects imparted by this high acid level, solubilized calcium and other trace minerals may still be needed. Accordingly, to minimize detrimental taste effects imparted by such high acid levels, a stabilized buffering protein component is included to ameliorate taste negatives that may be imparted by high acidity levels needed to solubilize significant levels of calcium and these trace minerals. In fact, the buffering protein component may provide formulation benefits in balancing the adverse taste effects imparted by high acid levels, solubilized calcium and trace minerals without any or minimal negative consequences of protein agglomeration and precipitation over time. The stabilized buffering protein component may comprise more than about 0.1% by weight of the total food or beverage product (e.g., in amounts of from about 0.1 to about 5% by weight, for example, from about 0.1 to about 2% by weight of the product), but with the total level of protein in the product depending upon the particular food (e.g., beverage) product involved.

Even so, stabilizing buffering protein components in such a high acid environment with high calcium concentrations presents additional challenges as proteins may denature, coagulate and precipitation over time when exposed to such an acidic environment and problematically with such high levels of calcium present. These proteins may also further react with fruit juice aromas and hydrolyze to short-chain peptides or amino acids that may result in undesirable bitter flavors. To counter these problems of denaturization, reaction, etc., the buffering protein component may be pre-acidified and stabilized in with a gum stabilizer prior to incorporation in the food product to thus stabilize and “protect” the buffering protein component in such high acid environments in the presence of high levels of calcium. This pre-acidification and stabilization of the buffering protein component may be carried out, for example, by forming a stabilized pre-acidified protein premix having a pH in the range of from about 3.0 to about 4.0 (e.g., from about 3.0 to about 3.8). The stabilized protein premix may be prepared, for example, by acidifying a solution of gum stabilizer; (e.g., pectin, a combination of high methoxy pectin and CMC, etc.), and protein, for example, dairy protein, soy protein, etc., or a combination of proteins, under high shear mixing conditions at a mix temperature of, for example, less than about 60° F. (16° C.) to form protein and stabilizer particles having a median particle size of less than about 0.8 microns (e.g., in the range of from about 0.2 to about 0.6 microns). The amount of gum stabilizer used may vary depending upon the type of gum stabilizer used, the protein buffering component involved, etc., and may be at least about 0.1% by weight of the final product. For example, the final product may include a gum stabilizer such as high methoxy pectin, carboxymethylcellulose, etc., in the range from about 0.1 to about 1% by weight of the final product. An acidulant, such as, for example, citric acid, may be used, to acidify this solution. After the stabilized acidified protein premix has been prepared with a pH near or about matched to the solubilized calcium and any fruit juices present, this protein premix may be added, combined, etc., with the other formulation ingredients to provide the final product. The final product often requires no further homogenization as is typically required for protein stabilized products, and is thus ready for conventional thermal processing, packaging, etc.

Embodiments of the calcium, vitamin D and other trace mineral supplemented and fortified products of the present invention may be fruit juice-based beverages having a pH in the range of from about 3.5 to about 4.0 and may comprise a stabilized buffering protein component in the range of from about 0.1 to about 5% by weight of the product. Embodiments of the present invention may also be used to prepare other calcium, vitamin D and trace mineral supplemented and fortified fruit juice-based food products.

One embodiment of a high acid calcium fortified beverage may contain about 0.189% by weight solubilized calcium and a protein source comprising from about 5 to about 10% skim milk by weight of the product. This beverage has high taste acceptance. At higher calcium fortification levels, total acidity may need to be increased in order to maintain calcium solubility and palatability. This higher acidity, however, may cause unacceptable sourness and unpleasant aftertastes. Accordingly, a protein buffering component is included to ameliorate this higher level of acidity and thus improve overall taste acceptance of the product without protein agglomeration and precipitation over time. The buffering capability of, for example, dairy and/or soy proteins, may be used to reduce or eliminate the intense sour aftertaste resulting from such a high acid environment which may be needed to fortify, for example, beverages with high levels of soluble calcium. Thus, the combination of the acid soluble calcium citrate malate complex with a stabilized buffering protein component may offer excellent compatibility to develop highly calcium-enriched beverage products which are stable and have excellent taste and palatability profiles.

Embodiments of beverages according to the present invention may be formulated to provide substantial levels of solubilized calcium (e.g., up to about 0.42% weight solubilized calcium) without generating the sour taste negatives or unpleasant aftertaste. Addition of a protein buffering component at, for example, levels of about 1 gm per 8 fl. oz. serving to formulations that contain up to about 0.42% weight solubilized calcium may reduce the intense sour aftertaste when compared to the formulations without addition of such a protein buffering component. This provides beverage products, concentrates, etc., which may deliver highly soluble and bioavailable calcium in a very palatable form. This combination of solubilized calcium citrate malate with a stabilized buffering protein component may be used in many food product forms, including but not limited to liquid supplements, meal replacements, spoonable matrices, frozen treats, etc.

The embodiments of the liquid food products of the present invention may include any product form comprising the essential ingredients described herein, and which is safe and effective for oral administration. The liquid food products may be formulated to include only the essential ingredients described herein, or may be modified with optional ingredients to form a number of different product forms. The liquid food products of the present invention may be formulated as dietary product forms, which are defined herein as those embodiments comprising the essential ingredients of the present invention in a product form that then contains fat, protein, and carbohydrate, and may also contain other vitamins, minerals, etc., or combinations thereof.

The embodiments of food products of the present invention may also include viscous liquid food product including food condiments (e.g., spreads, sauces, jams, jelly, coffee creamer, ketchup, mustard or sweetener), chocolate syrup, baking or cooking materials (e.g., fat substitutes or oil substitutes, butter substitutes or margarine substitutes), beverages (e.g., expresso, shakes, ice-cream based drinks), flowable cheeses, cream cheese, dips, dressings, frozen desserts (e.g., ice cream, fudge bars, frozen yogurt), pudding, flavored refrigerated dough (e.g., cookies, bread, brownies), milk or soy-based smoothies, yogurt or yogurt-based drinks, frozen yogurt, soy milk, soups, etc.

Embodiments of the food products of the present invention may desirably contain other vitamins and minerals in addition to calcium, vitamin D and trace minerals. Those skilled in the art will appreciate that minimum requirements may have been established for these other vitamins and minerals that are known to be necessary for normal physiological function. Those skilled in the art will also understand that appropriate additional amounts of these other vitamins and mineral ingredients may be needed to provide to food products to compensate for some loss during processing and storage of such products. Additionally, those skilled in the art understand that certain micronutrients may have potential benefit for people with diabetes such as chromium, carnitine, taurine, vitamin E, etc., and that higher dietary requirements may exist for certain micro nutrients such as, for example, ascorbic acid due to higher turnover in people with diabetes, etc.

An example of a vitamin and mineral system for an embodiment of a food product used as a meal replacement may comprise, in addition to vitamin D, at least about 10% of the Recommended Daily Intake (RDI) for the vitamins A, B₁, B₂, B₆, B₁₂, C, E, K, β-carotene, biotin, folic acid, pantothenic acid, niacin, choline, etc.; in addition to calcium and the one or more trace minerals, other minerals, including sodium, phosphorous, chloride, iodine chromium, molybdenum, selenium, etc.; the conditionally essential nutrients m-inositol, carnitine, taurine, etc., in a single serving of from about 50 Kcal to about 1000 Kcal.

Artificial sweeteners may also be added to the food product to enhance the organoleptic quality of the formula. Examples of suitable artificial sweeteners may include saccharine, aspartame, acesulfame K, sucralose, etc. Embodiments of the food products of the present invention may also include a flavoring and/or color to provide the food products with an appealing appearance and an acceptable taste for oral consumption. Examples of useful flavorings typically include, for example, strawberry, peach, butter pecan, chocolate, banana, raspberry, orange, blueberry and vanilla.

Embodiments of the food products of the present invention may also comprise proteins other than those required for the protein buffering component. The protein source may contain intact proteins, hydrolyzed proteins, peptides, amino acids, or any combination thereof. The proteins that may be utilized in the food products may include any edible protein suitable for human consumption. Examples of suitable proteins that may be utilized include soy proteins, milk proteins, cereal proteins, other vegetable proteins (e.g., from pea), and mixtures thereof. Commercial protein sources are readily available and known.

Embodiments of the food products of the present invention may also comprise fat. Suitable fats or sources thereof may include any that are known for or otherwise safe for use in an oral nutritional products, non limiting examples of which include coconut oil, fractionated coconut oil, soybean oil, corn oil, peanut oil, low erucic acid rapeseed oil (canola oil), olive oil, safflower oil, high oleic safflower oil, MCT oil (medium chain triglycerides), sunflower oil, high oleic sunflower oil, sesame seed oil, palm and palm kernel oils, palm olein, marine oils, cottonseed oils, flaxseed oils, cocoa butter, and combinations thereof. Numerous commercial sources for the fats listed above are readily available and known to skilled in the art.

The fat component may comprise in whole or in part polyunsaturated fatty acids, including polyunsaturated fatty acid esters or other natural or synthetic source, including short chain (less than about 6 carbon atoms per chain), medium chain (from about 6 to 18 carbon atoms per chain) and long chain (having at least about 20 carbon atoms per chain) fatty acids having two or more carbon:carbon double bonds, including n-3 (omega-3) and n-6 (omega-6) polyunsaturated fatty acids. Non limiting examples of polyunsaturated fatty acids suitable for use herein include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), linoleic acid (18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof.

Embodiments of the food products of the present invention may also comprise a flavorant, concentrations of which may vary substantially depending upon the selected flavorant and other ingredients, as well as the desired flavor profile or intensity desired. Any flavorant that is known or otherwise suitable for use in food products may be used herein, provided that such flavorant is also compatible with the other selected materials, ingredients, additives, etc.

Such flavorants may be natural or synthetic and can be provided by a single or multiple flavored materials. Flavorants for use in the food products are most typically a combination of many ingredients to provide the desired flavor association.

Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof.

Embodiments of the food products of the present invention may further comprise other optional components, materials, ingredients, additives, etc., that may modify the physical, chemical, aesthetic or processing characteristics of the food products. Many such optional components, materials, ingredients, additives, etc., that are known or otherwise suitable for use in other food products may also be used in the food products herein, provided that such optional components, materials, ingredients, additives, etc., are safe for human consumption and are compatible with the essential and other components, materials, ingredients, additives, etc., present in the food product. Non-limiting examples of other optional ingredients include preservatives, antioxidants, pharmaceutical actives, colorants, additional flavors, etc.

Embodiments of the food products of the present invention may further comprise other vitamins or related nutrients, non-limiting examples of which include vitamin A, vitamin C (e.g., ascorbic acid which may also function as an antioxidant), vitamin E, vitamin K, thiamine, riboflavin, pyridoxine, vitamins B₁, B₂, B₁₂, etc., carotenoids (e.g., β-carotene, zeaxanthin, lutein, lycopene), niacin, folic acid, pantothenic acid, biotin, choline, inositol, salts/conjugates and derivatives thereof, and combinations thereof.

These food products may further comprise other minerals, non-limiting examples of which include phosphorus, sodium, potassium, molybdenum, chromium (e.g., from chromium picolinate), chloride, etc., and combinations thereof.

Embodiments of the food products of the present invention may also be substantially free of any optional components, materials, ingredients, additives, etc., described herein. In this context, the term “substantially free” means that the selected product contains less than a functional amount of the optional components, materials, ingredients, additives, etc., including zero percent by weight of such optional components, materials, ingredients, additives, etc.

### EXAMPLES

### Example I

A buffering protein component is prepared by acidifying protein ingredient(s) using a commercial mixer (e.g., Waring Blender). Under continuous high speed blending, 6.6 g of pectin and 10.4 g of CMC gum are added to 700 g of 15° C. water. After blending for 2 minutes, 63 g of non-fat dry milk powder is added under continuous blending for another 2 minutes. Again while under continuous blending 7.5 g of citric acid is slowly added to lower the pH below 3.8. The particle size of the final acidified buffering protein premix is less than 0.8 microns.

### Example II

A ready-to-drink orange flavored beverage of the present invention is prepared from the following ingredients:

| Ingredient | % w/w |
|---|---|
| Water | 72% |
| Fructose | 4% |
| Orange Juice Premix | 15% |
| Non-Fat (Skim) Milk | 7% |
| Citric Acid | 0.55% |
| Malic Acid | 0.43% |
| Calcium Hydroxide | 0.35% |
| Pectin/Carboxymethylcellulose Blend (CMC) | 0.25% |
| Vitamin and Mineral Premix | 0.067% |
| Orange Flavors | 0.55% |

The beverage is prepared from the above ingredients as follows: Water, fructose, are first blended together in an appropriated sized blend tank. Citric acid, malic acid and the vitamin premix are then added and mixed until dissolved. A calcium hydroxide slurry is prepared and added to the acid mixture until fully dissolved. The orange juice premix and flavor components are then added to the batch.

The buffering protein component is prepared in a high shear mixer by loading the mixer with 15° C. water followed with the appropriate amounts of pectin and carboxymethylcellulose gums. After several minutes of blending, non-fat dry milk powder is added to the gum mixture and mixed. With continued high shear mixing, dry citric acid powder is added at a rate of 15 pounds per minute to a concentration of 80 mM. The pH value of the final mixture is generally less than 3.8. The median particle size of the protein/stabilizer particles ranges from 0.30 microns to 0.50 microns.

The pre-acidified buffering protein component is then added to the blend tank and mixed to homogeneity without the need for further homogenization. The final blend has a pH value of 3.7 to 4.1. The blend is pasteurized at 187±5° F. for 13±3 seconds and conventionally bottled.

### Example III

A strawberry/banana flavored ready-to-drink breakfast smoothie embodiment of the present invention is prepared according to the procedure of Example II, but with soy protein isolate and fiber using the following ingredients:

| Ingredient | % w/w |
|---|---|
| Water | 67% |
| Fructose | 10% |
| Strawberry Juice Premix | 15% |
| Soy Protein Isolate 78% Protein | 3% |
| Citric Acid | 0.32% |
| Malic Acid | 0.43% |
| Lactic Acid | 0.21% |
| Calcium Hydroxide | 0.35% |
| Fiber (Oligosaccharide) | 3% |
| Pectin/Carboxymethylcellulose Blend (CMC) | 0.35% |
| Vitamin C, D and Mineral Premix | 0.067% |
| Natural Strawberry Banana Flavors | 0.33% |

The beverage is prepared from the above ingredients as follows: Water, fructose, and fiber are first blended together in an appropriated sized blend tank. Citric acid, malic acid and the vitamin premix are then added and mixed until dissolved. A calcium hydroxide slurry is prepared and added to the acid mixture until fully dissolved. The strawberry juice premix and flavor components are then added to the batch.

The buffering protein component is prepared in a high shear mixer by loading the mixer with 15° C. water followed with the appropriate amounts of pectin and carboxymethylcellulose gums. After several minutes of blending, non-fat dry milk powder is added to the gum mixture and mixed. With continued high shear mixing, dry citric acid powder is added at a rate of 15 pounds per minute to a concentration of 80 mM. The pH value of the final mixture is generally less than 3.8. The median particle size of the protein/stabilizer particles is in the range from 0.30 microns to 0.50 microns.

The pre-acidified buffering protein component is then added to the blend tank and mixed to homogeneity without the need for further homogenization. The final blend has a pH value of from 3.7 to 4.1. The blend is pasteurized at 187±5° F. for 13±3 seconds and conventionally bottled.

### Example IV

Another embodiment of the present invention is prepared as a lemon/lime sparkling ready-to-drink carbonated refreshment beverage from the following ingredients:

| Ingredient | % w/w |
|---|---|
| Water | 83.68% |
| Fructose | 4.5% |
| Orange Juice Premix | 5% |
| Non-Fat (Skim) Milk | 5% |
| Citric Acid | 0.52% |
| Malic Acid | 0.48% |
| Calcium Hydroxide | 0.35% |
| Pectin/Carboxymethylcellulose Blend (CMC) | 0.2% |
| Vitamin C, D and Mineral Premix | 0.07% |
| Natural Lemon Lime Flavors | 0.2% |

The beverage is prepared from the above ingredients according to the procedure described in Example II. Carbon dioxide can be introduced either into the water mix or into the finished beverage to achieve the desired carbonation. The amount of carbon dioxide introduced of the present invention contain from about 1.0 to about 3.0 volumes of carbon dioxide. After carbonation, the beverage is then placed into the appropriate container such as a bottle or a can and then sealed.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A food product comprising:
calcium citrate malate in an amount providing a level of solubilized calcium of at least about 0.18% by weight of the product, and a level of total acids of at least about 0.7% by weight of the product;
vitamin D in an amount of at least about 10% of the RDA;
one or more trace minerals in an amount of at least about 10% of the RDA of each trace mineral provided; and
a stabilized buffering protein component.

2. The food product of claim 1, wherein the product is a beverage.

3. The food product of claim 2, wherein the beverage comprises fruit juice.

4. The food product of claim 1, wherein the amount of solubilized calcium is in the range of from about 0.18 to about 0.42% by weight of the product.

5. The food product of claim 1, wherein the stabilized buffering protein component comprises one or more soy proteins.

6. The food product of claim 1, wherein the stabilized buffering protein component comprises one or more dairy proteins.

7. The food product of claim 1, wherein the stabilized buffering protein component comprises one or more soy proteins and one or more dairy proteins.

8. The food product of claim 1, wherein the stabilized buffering protein component comprises at least about 0.1% by weight of the product.

9. The food product of claim 1, wherein the stabilized buffering protein component comprises about 0.1% to about 5% by weight of the product

10. The food product of claim 1, wherein the level of total acids is in the range of form about 0.7 to about 2.6% by weight of the product.

11. The food product of claim 1, wherein the product has pH is about 4.2 or less.

12. The food product of claim 11, wherein the pH is in the range of from about 2.5 to about 4.2.

13. The food product of claim 12, wherein the pH is in the range of from about 3.0 to about 4.0.

14. The food product of claim 1, wherein the one or more trace minerals comprise iron, zinc, magnesium, manganese, copper, or mixtures thereof.

15. The food product of claim 14, wherein the one or more trace minerals further comprises potassium.

16. The food product of claim 1, wherein citric acid and malic acid are present in the product in a weight ratio of citric acid to malic acid in the range of from about 2:1 to about 1:3.

17. The food product of claim 1, wherein the product further comprises a gum stabilizer.

18. The food product of claim 17, wherein the gum stabilizer comprises one or more of pectin, gum acacia, cellulose gums, modified food starches, guar gum, xanthan gum, locust bean gum, gellan gum, gum arabic furcellaran, alginates, carrageenans, or agaroid gums in an amount of at least about 0.1% by weight of the product.

19. The food product of claim 18, wherein the gum stabilizer comprises a high methoxy pectin having a degree of methoxylation of greater than about 50%.

20. The food product of claim 18, wherein the gum stabilizer comprises carboxymethylcellulose.

21. The food product of claim 18, wherein the gum stabilizer comprises a combination of high methoxy pectin having a degree of methoxylation of greater than about 50% and carboxymethylcellulose in an amount from about 0.1 to about 1% by weight of the product.

22. A method comprising the following steps:
(a) providing a stabilized acidified buffering protein component; and
(b) combining the stabilized acidified buffering protein component with the remaining food product ingredients comprising calcium citrate malate and one or more trace minerals to form a calcium, vitamin D and trace mineral fortified food product, wherein the calcium citrate malate is in amount to provide a level of solubilized calcium of at least about 0.18% by weight of the food product, and a level of total acids of at least about 0.7% by weight of the food product, wherein the vitamin D is in an amount of at least about 10% of the RDA, and wherein the one or more trace minerals are in an amount to provide at least about 10% of the RDA of each trace mineral provided.

23. The method of claim 22, wherein the stabilized acidified buffering protein component of step (a) is formed by acidifying a solution comprising a gum stabilizer and a buffering protein component under high shear mixing conditions at a temperature of less than about 60° F.

24. The method of claim 22, wherein the solution is acidified with citric acid.

25. The method of claim 22, wherein the gum stabilizer comprises a combination of high methoxy pectin having a degree of methoxylation of greater than about 50% and carboxymethylcellulose in an amount of from about 0.1 to about 1% by weight of the food product of step (b).

26. The method of claim 22, wherein the stabilized acidified buffering protein component of step (a) comprises protein and stabilizer particles having a particle size of less than about 0.8 microns.

27. The method of claim 22, wherein the stabilized acidified buffering protein component of step (a) comprises protein and stabilizer particles having a particle size in the range of from about 0.2 to about 0.6 microns.

28. The method of claim 22, wherein the stabilized acidified buffering protein component of step (a) is formed from dairy protein, soy protein, or a combination thereof in an amount of from about 0.1 to about 5% by weight of the food product of step (b).

29. The method of claim 28, wherein the stabilized acidified buffering protein component of step (a) is formed from dairy protein.

30. The method of claim 28, wherein the stabilized acidified buffering protein component of step (a) is formed from soy protein.

31. The method of claim 22, wherein the food product of step (b) is not further homogenized.
